(19) United States
(12) Patent Application Publication
(10) Pub. No.: US 2015/0234901 A1
(43) Pub. Date: Aug. 20, 2015

(54) Data Collector and Associated Method, Computer Program and Computer Program Product

(71) Applicants: Simon Moritz, Stockholm (SE); Rickard Coster, Hagersten (SE); Tony Larsson, Upplands Vasby (SE); Stefano Zappaterra, Genova (IT)

(72) Inventors: Simon Moritz, Stockholm (SE); Rickard Coster, Hagersten (SE); Tony Larsson, Upplands Vasby (SE); Stefano Zappaterra, Genova (IT)

(73) Assignee: Telefonaktiebolaget L M Ericsson (publ), Stockholm (SE)

(21) Appl. No.: 14/431,629

(22) PCT Filed: Aug. 30, 2012
(86) PCT No.: PCT/SE2012/050922

§ 371 Date: Mar. 26, 2015

(51) Int. Cl. G06F 17/30

(52) U.S. Cl. CPC G06F 17/30539; G06F 17/30864; G06F 17/30353; G06F 17/30241

(57) ABSTRACT

It is presented a data collector arranged to collect data regarding application usage in an end user device. The data collector is arranged to be located in a mobile communication network between the end user device and a server. The data collector comprises: a processor; and a computer program product storing instructions that, when executed by the processor, causes the data collector to: obtain data sent between the end user device and the server; match the data against a list of patterns; and when a matching pattern is found in the list of patterns, store application activity associated with the matching pattern in a database for application usage.

### TECHNICAL FIELD

The invention relates to a data collector arranged to collect data regarding application usage in an end user device.

### BACKGROUND

Recommender systems are known in the art and are used for various purposes, such as recommending movies, music, pictures etc. Such recommender systems are for instance used by Amazon, Last.fm, etc. Recommender systems assist a user in finding interesting items without the user having to explicitly state what he or she wants.

A commonly used recommender method is collaborative filtering which produces recommendations by computing the similarity between users and/or items based on consumption history. Another well-known recommender method is content based recommendation. In essence, content based recommendations are based on a description, such as metadata, associated with the content. From a user's item consumption, preferences of the user in terms of item attributes are derived, to thereby find similar items.

One area where recommendations are applicable is applications (also known as apps) on smartphones, TVs, tablets and similar devices, that support the download and installation of applications by the end user. The number of applications available in different app stores is exploding, making it very hard for users to find applications that are relevant for them. By introducing a recommender system, this process is made easier for the end-users.

There are recommender systems known in the art. For example, Apple has provided a recommender system called Genius for applications on their iOS platform. However, such systems are limited in the data for basing the recommendations on.

### SUMMARY

It is an object to provide more relevant data regarding application usage for use by recommender systems.

According to a first aspect, it is presented a data collector arranged to collect data regarding application usage in an end user device. The data collector is arranged to be located in a mobile communication network between the end user device and a server. The data collector comprises: a processor; and a computer program product storing instructions that, when executed by the processor, causes the data collector to: obtain data sent between the end user device and the server; match the data against a list of patterns; and when a matching pattern is found in the list of patterns, store application activity associated with the matching pattern in a database for application usage.

Using a data collector located in a mobile communication network between the end user device and the server provides an opportunity to extract greatly relevant data. The pattern matching makes such data extraction relevant, even when a large amount of data is sent between the end user device and the server.

The instructions to match may comprise instructions to match a uniform resource identifier, URI, comprised in the data with the list of patterns. The URI, or other metadata, can be an efficient way to gain knowledge of a variety of application actions performed by the user.

The instructions to match may comprise instructions to match payload data of the data with the list of patterns. By matching patterns in payload data, it is possible to catch additional user actions regarding an application.

The instructions to store may comprise instructions to store a timestamp in the database. The timestamp can e.g. be used for analysis of when application usage, such as time of day, weekend, etc.

The computer program product may further comprise instructions to obtain additional data associated with the end user device; and the instructions to store may comprise instructions to store the additional data. Additional data can e.g. include location data. Optionally, the additional data can include subscriber data available through subscriber management systems of the mobile communication network.

The instructions to store may refrain from storing a user identifier. This improves privacy for the end user.

The computer program product may further comprise instructions to: reduce accuracy of any geographical location data associated with the end user device; and the instructions to store may comprise instructions to store the geographical location data with reduced accuracy. By not storing the exact location of the end user, privacy of the end user is improved.

The application activity may be an application activity in the list consisting of application installation, application uninstallation, application usage, application search in an application directory, and application usage duration. These are all application activities which can be used by a recommender system to provide application recommendations.

The network node may be arranged to be provided in a core network node of the mobile communication network.

According to a second aspect, it is presented a method for collecting data regarding application usage in an end user device, the method being performed in a data collector located between the end user device and a server. The method comprises the steps of: obtaining data sent between the end user device and the server; matching the data against a list of patterns; and when a matching pattern is found in the list of patterns, storing application activity associated with the matching pattern in a database for application usage.

The step of matching may comprise matching a uniform resource identifier comprised in the data with the list of patterns.

The step of matching may comprise matching payload data of the data with the list of patterns.

The step of storing may comprise storing a timestamp in the database.

The method may further comprise the step of: obtaining additional data associated with the end user device; and the step of storing may comprise storing the additional data.

The step of storing may refrain from storing a user identifier.

The method may further comprise the step of: reducing accuracy of any geographical location data associated with the end user device; and the step of storing may comprise storing the geographical location data with reduced accuracy.

In the step of storing, the application activity may be an application activity in the list consisting of application installation, application uninstallation, application usage, application search in an application directory, and application usage duration.

According to a third aspect, it is presented a computer program for collecting data regarding application usage in an end user device. The computer program comprises computer program code which, when run on a data collector located between an end user device and a server, causes the data collector to: obtain data sent between the end user device and the server; match the data against a list of patterns; and when a matching pattern is found in the list of patterns, store application activity associated with the matching pattern in a database for application usage.

According to a fourth aspect, it is presented a computer program product comprising a computer program according to the third aspect and a computer readable means on which the computer program is stored.

It is to be noted that any feature of the first, second, third or fourth aspects can, where applicable, form part of any other aspect.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a mobile communication system where embodiments presented herein can be applied;

FIGS. 2A-D are schematic diagram illustrating various nodes of FIG. 1 where a data collector can be housed;

FIG. 3 is a schematic diagram illustrating some components of the data collector of FIGS. 2A-D;

FIGS. 4A-B are flow charts illustrating two methods performed in the data collector of FIGS. 2A-D and FIG. 3 for collecting data regarding application usage in an end user device; and

FIG. 5 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

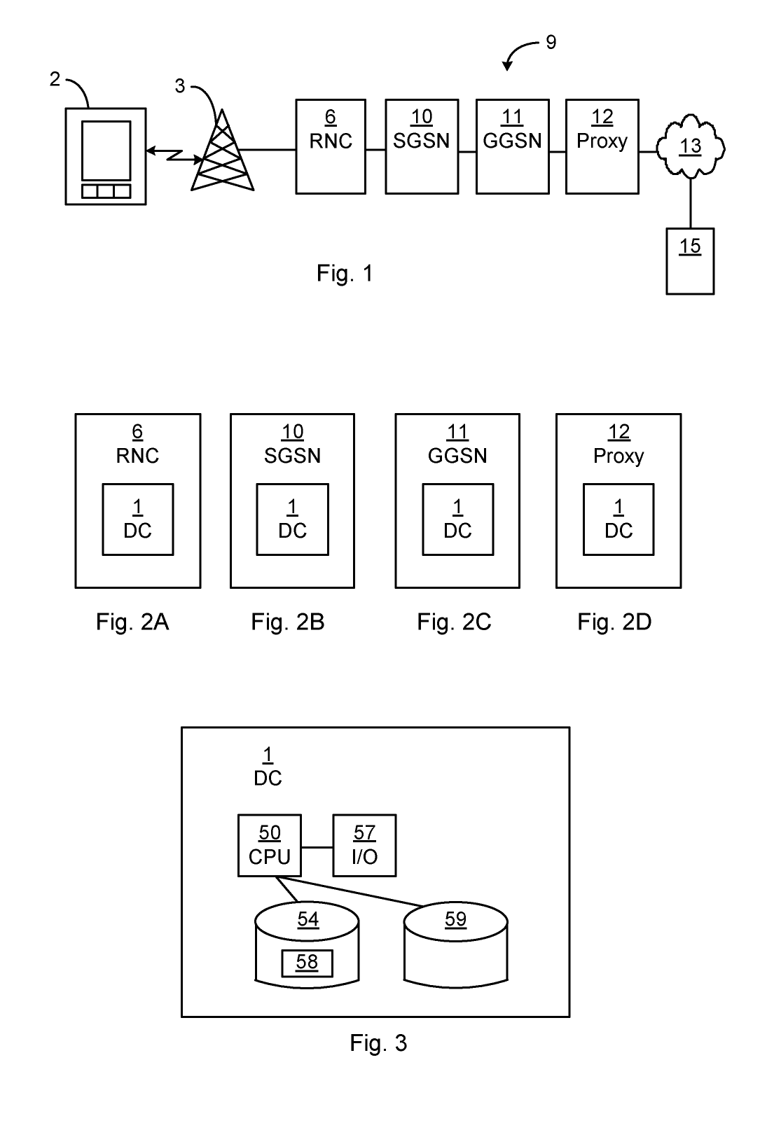

FIG. 1 is a schematic diagram illustrating a mobile communication system 9 where embodiments presented herein can be applied. The mobile communications system 9 comprises one or more network nodes 3, being a radio base station such as evolved Node Bs, also known as eNode Bs or eNBs. The network node 3 could also be in the form of Node Bs, BTSs (Base Transceiver Stations) and/or BSSs (Base Station Subsystems). In any case, each network node 3 provides radio connectivity to one or more end user devices 2. The term end user devices 2 is to be interpreted as any device usable by an end user and which is capable of wireless communication with the network node 3. The end user device 2 is also known as mobile communication terminal, user equipment, mobile terminal, user terminal, user agent, etc.

The mobile communication system 9 can e.g. comply with any one or a combination of LTE (Long Term Evolution), W-CDMA (Wideband Code Division Multiplex), EDGE (Enhanced Data Rates for GSM Evolution, GPRS (General Packet Radio Service)), CDMA2000 (Code Division Multiple Access 2000), etc., or any other existing or future mobile communication system standard, as long as the principles described hereinafter are applicable.

The network nodes 3 are also optionally connected to a radio network controller (RNC) 6 which is overall responsible for coordinating radio communication. The RNC is further connected via a Serving GPRS (General Packet Radio Service) Support Node (SGSN) 10, a gateway GPRS Support Node (GGSN) 11, and a proxy 12 to a wide area network 13.

The SGSN 10 routes data uplink and downlink and is responsible for management of the end user devices, such as attach/detach and location data. The GGSN 11 is the traditional gateway between the mobile communication network and external data networks such as the wide area network 13. The wide area network 13 can e.g. be the Internet.

Optionally, there is a proxy provided between the GGSN 11 and the wide area network 13.

There are furthermore one or more servers 15 connected to the wide area network 13. In this way, the end user device can communicate in either direction with the server 15.

One server 15 can house an application directory. The application directory allows a user of the end user device 2 to browse lists of applications which can be installed on the end user device 2. Furthermore, the application directory provides detailed data about the applications and links to install and/or uninstall the applications in the end user device 2. Furthermore, another server 15 can house the server end of an application installed in the end user device 2.

Regardless of the purpose of the server 15, the communication to and from the server 15 passes through the RNC 6, the SGSN 10, the GGSN 11 and the proxy 12, allowing the data sent between the end user device 2 and the server 15 in order to be analysed to extract data, e.g. regarding application usage in the end user device 2.

FIGS. 2A-D are schematic diagram illustrating various nodes of FIG. 1 where a data collector 1 can be housed. The data collector 1 collects data regarding application usage in the end user device and can thus be located in any host device anywhere along the path between the end user device 2 and the server 15.

In FIG. 2A, an embodiment is shown where the data collector 1 is located in the RNC 6, whereby the RNC 6 is the host device. In FIG. 2B, an embodiment is shown where the data collector 1 is located in the SGSN 10, whereby the SGSN 10 is the host device. In FIG. 2C, an embodiment is shown where the data collector 1 is located in the GGSN 11, whereby the GGSN 11 is the host device. In FIG. 2D, an embodiment is shown where the data collector 1 is located in the proxy 12, whereby the proxy 12 is the host device.

Optionally, different data collectors 1 or different parts of the data collector 1 can be housed in multiple devices.

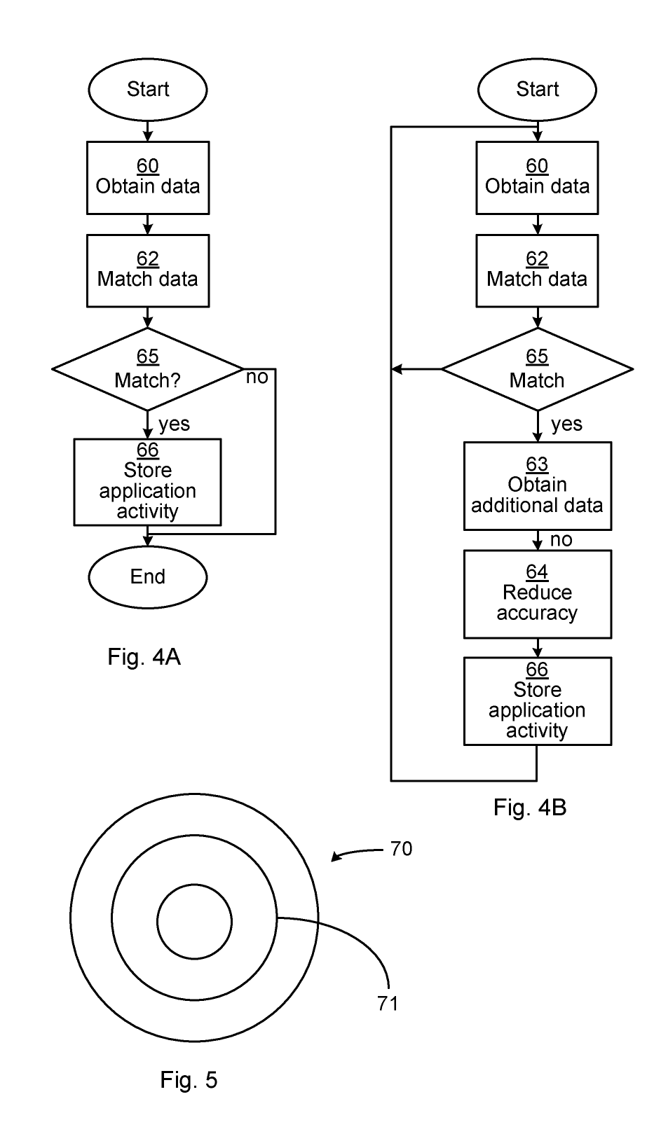

FIG. 3 is a schematic diagram showing some components of the data collector 1 of FIGS. 2A-D. The components shown here can be components used from the host device or components for the data collector, separate from the host device. A processor 50 is provided using any combination of one or more of a suitable central processing unit (CPU), multiprocessor, microcontroller, digital signal processor (DSP), application specific integrated circuit etc., capable of executing software instructions contained in a computer program 58 stored in a computer program product 54, e.g. in the form of a memory, but not in the form of a signal or any form of electromagnetic wave. The processor 50 can be configured to execute the method described with reference to FIGS. 4A-B below.

The computer program product 54 can be a memory being any combination of read and write memory (RAM) and read only memory (ROM). The memory also comprises persistent storage, which, for example, can be any single one or combination of magnetic memory, optical memory, solid state memory or even remotely mounted memory. The processor 50 controls the general operation of the data collector 1.

The data collector 1 further comprises a data memory 59, being a read and write memory. The data memory 59 may also comprise persistent storage, which, for example, can be any single one or combination of magnetic memory, optical memory, solid state memory or even remotely mounted memory. Optionally, the computer program product 54 and the data memory 59 can form part of the same memory.

The data collector 1 further comprises an I/O interface 57 for communicating with other devices. Other components of the data collector 1 are omitted in order not to obscure the concepts presented herein.

FIGS. 4A-B are flow charts illustrating two methods performed in the data collector of FIGS. 2A-D, 3 for collecting data regarding application usage in an end user device. First, the method shown in FIG. 4A will be discussed.

In an obtain data step 60, data sent between the end user device and the server is obtained. This step can e.g. be part of the routing functions of the host device.

In a match data step 62, the data is matched against a list of patterns. The list of patterns can e.g. be stored in a table, where each pattern is associated with an application activity. The application activity can e.g. be application installation, application uninstallation, application usage, application search in an application directory. Other possible application activities are: rating of an application, liking an application, unliking an application. Also, the installation duration, defined as time between install and install of an application can be obtained. The patterns can for example be based on regular expressions (regexp).

The matching can for instance use a uniform resource identifier (URI) comprised in the data and match the URI with the list of patterns. Often, the URI contains commands for application installation or uninstallation, or commands for showing more data of an application in an application directory, etc. Alternatively or additionally other metadata can be used, such as header fields, etc.

Alternatively or additionally, the matching can use payload data of the data and match this with the list of patterns, e.g. using deep packet inspection (DPI).

In the conditional match step 65, the method is routed to a store application activity step 66 when a matching pattern is found in the list of patterns in the match data step 62. Otherwise, the method ends.

In the store application activity step 66, the application activity associated with the matching pattern is stored as application activity data in a database for application usage. Optionally, a timestamp is stored in the application activity data in the database for application usage. The timestamp can be the current time of the host device, a time extracted from the data or any other suitable time which is at least comparable to timestamps in other records in the database for application usage. This can be used for evaluation of time-of-day of an event, weekday/weekend, etc.

Optionally, the store application activity step 66 refrains from storing a user identifier, even if such an identifier has been obtained from the data. This may e.g. be due to privacy reasons as configured by the operator of the mobile communication network or by the end user.

By removing the user identifier, individual users are effectively decoupled from the application activity data to prevent, e.g. the ability to read that user X used application Y at location Z.

Preserving end user privacy can be done in several different ways. This can be done during data collection, by removing user identifier (key) from the data or during subsequent popularity calculations

During data collection, the user identity could be refrained from being stored at all, i.e. consumption data for a certain application does not need any user identity correlated to it.

By removing the key from the data, it is possible to keep statistical data without risking the privacy of the end user. This process can periodically generate random identifiers for the data (e.g. every hour), which makes it possible to keep track of users at a certain location, but not follow them over time. Of course, the actual data with the real key can still be forwarded to services that the user signed up to, which makes it possible for e.g. recommender systems to build collaborative filtering models on the usage data, without any need for background services on the actual clients.

During popularity calculations for a certain application all relevant consumption data for that application will be used. The amount of data can in this case vary from only a single entry to several thousands of entries. In the case of only one data entry, the exact location can be obfuscated by introducing an error to it. In the case there is a lot of data, all data can be used to calculate an average location for this application.

Optionally, as part of the store application activity step 66, a duration of application usage is calculated and stored in the database for application usage. This duration can e.g. be calculated as a time difference between the first active message for a particular application and the last active message for a particular application. The application usage duration can be reset after a certain period of inactivity, e.g. after 30 minutes of activity.

Optionally, the collected application activity data is aggregated prior to storing. Once the application activity data is stored in the database, the application activity data can be used by recommender systems, such as an application recommender system. The recommender system can then use the application activity data to calculate what application to recommend to different end users.

The recommendation of applications can, for example, be calculated based on:
Geographical area, such as the most popular applications in Sweden, most popular applications in Stockholm or even on a street level, most popular applications close to Kistagingen 26.
Time of day: What applications are most popular at a certain time, like for instance what applications are most popular around lunch.
Day of week: Calculate most popular applications on a certain day of the week, or weekdays vs. weekends.
Application category: Only calculate most popular applications in certain category, e.g. utilities, games.
All mentioned dimension above can also be combined so that it is possible, for instance, to find most popular applications in Stockholm around lunch time on Wednesdays.

In one example, the process comprises the following steps:
Get relevant consumption data to do calculations on. This basically means querying the database specifying certain criteria's: geographical area, time, day of week, application category etc. (same criteria as described above).
Calculate popularity rank for each application. The popularity rank is can e.g. be a value between 0 and 1 where 0 is lowest popularity and 1 is highest popularity. The exact formula to do the calculations is not essential to the embodiments described herein.

The method shown in FIG. 4B is similar to the method shown in FIG. 4A. Thus, only the differences to the method of FIG. 4A will described here and the steps of FIG. 4A will not be described again.

Here, the method is routed, in the conditional match step 65, to an obtain additional data step 63 when there is a match. Otherwise, the method returns to the obtain data step 60 to repeat the method.

In the optional obtain additional data step 63, additional data associated with the end user device is obtained. For example, geographical location can be obtained, either from a node in the mobile communication system of from the end user device.

The additional data could also be based on collecting other types of information, such as information from the Internet, weather channels, street maps, calendars etc. For example, the data collector can derive that there is a football game going on in the area or that bad weather is to occur in the region. Street maps and calendars may also add additional information such as public holidays and other metadata about the area.

In the optional reduce accuracy step 64, accuracy of any geographical location data associated with the end user device is reduced. For example, the geographical location could be stored as GPS coordinates with a reduced number of significant digits or with reference to a city or a region, even though greater accuracy is available.

In the store application activity step 66, the additional data is stored in the database for application data along with the application activity associated with the matching pattern. Also, when the reduce accuracy step 64 is performed, the geographical location data is stored with reduced accuracy, as explained above, to improve user privacy.

After the store application activity step 66, the method returns to the obtain data step 60.

FIG. 5 shows one example of a computer program product 70 comprising computer readable means. On this computer readable means a computer program 71 can be stored, which computer program 71 can cause a controller to execute a method according to embodiments described herein. In this example, the computer program product is an optical disc, such as a CD (compact disc) or a DVD (digital versatile disc) or a Blu-Ray disc. As explained above, the computer program product could also be embodied as a memory of a device, such as the computer program product 54 of FIG. 3. While the computer program 71 is here schematically shown as a track on the depicted optical disk, the computer program can be stored in any way which is suitable for the computer program product.

The invention has mainly been described above with reference to a few embodiments. However, as is readily appreciated by a person skilled in the art, other embodiments than the ones disclosed above are equally possible within the scope of the invention, as defined by the appended patent claims.

1. A data collector arranged to collect data regarding application usage in an end user device, the data collector comprising:
a processor; and
a computer program product storing instructions that, when executed by the processor, causes the data collector to:
obtain data sent between the end user device and a server;
match the obtained data against a list of patterns; and
when a pattern is found in the list of patterns that matches the obtained data, store application activity data associated with the matching pattern in a database for application usage.

2. The data collector according to claim 1, wherein the instructions for matching the obtained data against the list of patterns comprises instructions for matching a uniform resource identifier comprised in the obtained data against the list of patterns.

3. The data collector according to claim 1, wherein
the obtained data comprises a packet comprising a header and a data payload, and
the instructions for matching the obtained data against the list of patterns comprises instructions to match payload data from the data payload of the packet of the data with against the list of patterns.

4. The data collector according to claim 1, wherein the instructions to store comprise instructions to store a timestamp in the database.

5. The data collector according to claim 1, wherein the computer program product further comprises instructions to obtain additional data associated with the end user device; and wherein the instructions to store comprise instructions to store the additional data.

6. The data collector according to claim 1, wherein the instructions to store refrains from storing a user identifier.

7. The data collector according to claim 1, wherein the computer program product further comprising instructions to: reduce accuracy of any geographical location data associated with the end user device; and wherein the instructions to store comprise instructions to store the geographical location data with reduced accuracy.

8. The data collector according to claim 1, wherein the application activity is an application activity in the list consisting of application installation, application uninstallation, application usage, application search in an application directory, and application usage duration.

9. A network node comprising a data collector according to claim 1, wherein the network node is arranged in a core network node of the mobile communication network.

10. A method for collecting data regarding application usage in an end user device, the method being performed in a data collector located between the end user device and a server, the method comprising the steps of:
obtaining data sent between the end user device and the server;
matching the data against a list of patterns; and
when a matching pattern is found in the list of patterns, storing application activity data associated with the matching pattern in a database for application usage.

11. The method according to claim 10, wherein the step of matching comprises matching a uniform resource identifier comprised in the data with the list of patterns.

12. The method according to claim 10, wherein the step of matching comprises matching payload data of the data with the list of patterns.

13. The method according to claim 10,
wherein the step of storing comprises storing a timestamp in the database.

14. The method according to claim 10, further comprising the step of:
obtaining additional data associated with the end user device;
and wherein the step of storing comprises storing the additional data.

15. The method according claim 10,
wherein the step of storing refrains from storing a user identifier.

16. The method according claim 10,
further comprising the step of:
reducing accuracy of any geographical location data associated with the end user device;
and wherein the step of storing comprises storing the geographical location data with reduced accuracy.

17. The method according to claim 10,
wherein, in the step of storing, the application activity is an application activity in the list consisting of application installation, application uninstallation, application usage, application search in an application directory, and application usage duration.

18. A computer program product comprising a non-transitory computer readable medium storing a computer program for collecting data regarding application usage in an end user device, the computer program comprising computer program code which, when run on a data collector located between the end user device and a server, causes the data collector to:
obtain data sent between the end user device and the server;
match the data against a list of patterns; and
when a matching pattern is found in the list of patterns, store application activity associated with the matching pattern in a database for application usage.

19. (canceled)

20. The method according to claim 10, wherein
at least one pattern in the list of patterns is associated with an application activity selected from a group of application activities consisting of: application installation, application uninstallation, application usage, and application search,
the step of obtaining data sent between the end user device and the server comprises receiving a packet transmitted by either the end user device or the server, wherein the packet is destined for the server or the end user device and the packet has a header and a data payload,
the step of matching the data against the list of patterns comprises: i) extracting payload data from the data payload of the packet and ii) determining whether a pattern in the list of patterns matches the extracted payload data,
the application activity data stored in the storing step identifies a certain application activity, and
the method further comprises transmitting the packet towards the server or the end user device.
